(19) United States
(12) Patent Application Publication
(10) Pub. No.: US 2026/0063056 A1
(43) Pub. Date: Mar. 5, 2026

(54) SUPERCRITICAL CATALYTIC CONVERTER

(71) Applicant: High Alert Institute, Inc., Lake Wales, FL (US)

(72) Inventors: Maurice A. Ramirez, Lake Wales, FL (US); J. Chris Ford, Lake Wales, FL (US)

(21) Appl. No.: 19/312,258

(22) Filed: Aug. 27, 2025

Related U.S. Application Data
(60) Provisional application No. 63/688,844, filed on Aug. 29, 2024.

(51) Int. Cl. F01K 7/32; F01K 7/26; F01K 25/10

(52) U.S. Cl. CPC F01K 7/32; F01K 7/26; F01K 25/103

(57) ABSTRACT

An integrated thermal processing and energy conversion system includes a supercritical water oxidation (SCWO) reactor configured to oxidize liquid chemical waste at supercritical conditions, producing heat, CO2, and a mineral-rich slurry. A thermal recovery and storage unit captures heat from the SCWO reactor and uses it to heat pressurized supercritical CO2 (SCCO2), which is expanded through an SCCO2 turbine to generate mechanical and electrical power. The system includes a dry gas fractionator to separate SCCO2 gas from the slurry, a mineral carbonate generator to convert slurry and CO2 into dry mineral carbonates, and a recuperator for recovering additional heat. Cooled CO2 is compressed and stored or directed to a gas mixer for reuse in the SCWO process. Control systems coordinate temperature, pressure, and flow throughout the system. The configuration enables continuous waste treatment, heat recovery, and power generation from interconnected fluid and thermal streams.

### CROSS REFERENCE TO RELATED APPLICATIONS

This application claims priority as a non-provisional application to U.S. provisional application No. 63/688,844, titled “Supercritical Catalytic Converter,” filed on Aug. 29, 2024, the contents of which are incorporated herein in their entirety.

### BACKGROUND

The disposal of carbon-based waste materials, including organic chemicals, sewage sludge, oil sludge, well gas, chemical waste, and chemical munitions, often requires high-temperature processing. Common disposal methods include bioreaction, incineration, thermal decomposition, and direct combustion. These processes are designed to convert the carbon-containing materials into carbon dioxide (CO2), other gases, mineral residues, and water vapor.

Electrical power generation typically involves producing hot gas or steam under pressure to drive a turbine. The turbine, in turn, drives a generator to produce electricity. In open-cycle systems such as the Brayton cycle, the working fluid is vented to the atmosphere after passing through the turbine. In closed-loop systems such as the Rankine cycle, the working fluid is condensed and recirculated.

Waste-to-energy (WTE) systems generate power from waste materials using the principles of the Brayton or Rankine cycles. In some systems, waste is used directly as a fuel to produce heat, while in others, waste heat generated during disposal processes such as combustion or decomposition is recovered to produce steam for power generation.

Despite their widespread use, conventional waste disposal and energy generation methods present several drawbacks. Processes such as incineration, thermal decomposition, and direct combustion often result in the release of harmful emissions, including greenhouse gases, nitrogen oxides, sulfur compounds, and particulate matter. Additionally, these methods may generate residual ash or sludge that requires further treatment or disposal. In waste-to-energy systems, overall efficiency can be limited by thermodynamic constraints, especially in open-cycle configurations where waste heat is not recovered. Furthermore, the reliance on combustion-based processes for both waste treatment and energy production contributes to cumulative environmental impacts, including air pollution and carbon emissions.

Supercritical Water Oxidation (SCWO) is a WTE technology capable of processing a broad range of organic waste streams, including materials that are difficult to recycle or treat using conventional methods. SCWO is effective for processing substances such as plastics, microplastics, water filters, and sludges containing per- and polyfluoroalkyl substances (PFAS) and pharmaceutical residues. Operating above the critical point of water, SCWO promotes rapid and near-complete oxidation of organics, resulting in outputs such as water, CO2, and mineral solids. The process can significantly reduce waste volume and enables separation of water from other reaction products under supercritical conditions.

However, SCWO requires oxygen as an oxidant, with one mole of oxygen consumed and one mole of CO2 produced for each mole of carbon oxidized. In addition to CO2 emissions, the process generates substantial quantities of waste heat.

Supercritical CO2 (SCCO2) power cycle technologies use CO2 above its critical point as a working fluid to convert heat into mechanical or electrical energy. These systems can achieve high thermal efficiencies and allow for compact equipment designs. However, achieving and maintaining supercritical conditions requires a considerable energy input. In many implementations, the energy used to heat the CO2 is derived from combustion sources, which reintroduces emissions comparable to those from conventional Brayton or Rankine cycles.

Accordingly, there is a need for improved methods of converting heat to usable energy with increased efficiency and reduced environmental impact.

### SUMMARY

Examples described herein include integrated thermal and energy conversion system configured to process chemical and waste streams while generating mechanical and electrical power. In one implementation, an SCWO reactor is configured to oxidize liquid chemical waste in the presence of water at conditions above the critical point, producing hot water, mineral-rich slurry, CO2, and other gases. Heat generated by the SCWO reaction can be recovered through a thermal recovery and storage manifold or unit, which transfers the recovered heat to pressurized SCCO2 for delivery to an SCCO2 turbine.

The SCCO2 turbine expands the heated and pressurized SCCO2 to produce mechanical power, which is converted to electrical power and conditioned through a power generation control system, power phase synchronizer, and anti-islanding switch for distribution over a power distribution bus. Exhaust from the SCCO2 turbine is cooled in the thermal recovery and storage unit, with excess heat optionally transferred to additional power-producing devices. The cooled CO2 is then compressed and stored, or mixed with other gases for reintroduction into the SCWO reactor. In certain embodiments, a dry gas fractionator can separate hot, dry SCCO2 exhaust from hot mineral slurry for downstream processing in a mineral carbonate generator, which combines the slurry, feedstock minerals or slag, and hot dry SCCO2 to generate dry mineral carbonates, argon gas, and additional heat.

In further embodiments, the SCWO reactor can be coupled to a steam generator that converts supercritical water (SCH2O) into superheated steam for driving a steam turbine connected to industrial processes or electrical generation equipment. Exhaust steam from the steam turbine can be processed in a recuperator and recirculated as water to the SCWO reactor. Control systems can coordinate the operation of the SCWO reactor, SCCO2 turbine, steam turbine, and related subsystems to optimize thermal recovery, process efficiency, and product handling.

The examples summarized above can each be incorporated into a non-transitory, computer-readable medium having instructions that, when executed by a processor associated with a computing device, cause the processor to perform the stages described. Additionally, the example methods summarized above can each be implemented in a system including, for example, a memory storage and a computing device having a processor that executes instructions to carry out the stages described.

Both the foregoing general description and the following detailed description are exemplary and explanatory only and are not restrictive of the examples, as claimed.

### BRIEF DESCRIPTION OF THE DRAWINGS

FIG. 1 is a diagram of a supercritical catalytic converter system.

FIG. 2 is a simple flowchart of a supercritical catalytic converter system.

FIG. 3 is a detailed flowchart of a supercritical catalytic converter system.

FIG. 4 is an example illustration of a super catalytic converter system.

FIG. 5 is an illustration of an example method for operating a super catalytic converter system.

### DESCRIPTION OF THE EXAMPLES

Reference will now be made in detail to the present examples, including examples illustrated in the accompanying drawings. Wherever possible, the same reference numbers will be used throughout the drawings to refer to the same or like parts.

An integrated thermal processing and energy conversion system includes a supercritical water oxidation (SCWO) reactor configured to oxidize liquid chemical waste at supercritical conditions, producing heat, CO2, and a mineral-rich slurry. A thermal recovery and storage unit captures heat from the SCWO reactor and uses it to heat pressurized SCCO2, which is expanded through an SCCO2 turbine to generate mechanical and electrical power. The system includes a dry gas fractionator to separate SCCO2 gas from the slurry, a mineral carbonate generator to convert slurry and CO2 into dry mineral carbonates, and a recuperator for recovering additional heat. Cooled CO2 is compressed and stored or directed to a gas mixer for reuse in the SCWO process. Control systems coordinate temperature, pressure, and flow throughout the system. The configuration enables continuous waste treatment, heat recovery, and power generation from interconnected fluid and thermal streams.

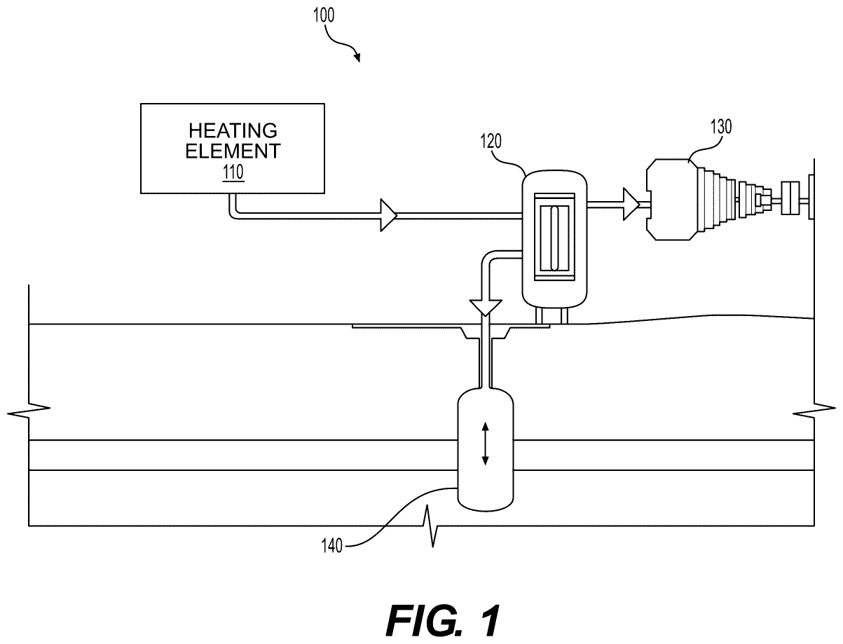

FIG. 1 is a diagram of a supercritical catalytic converter 100. The supercritical catalytic converter 100 can include a heating device 110, an SCWO reactor 120, and an SCCO2 turbine 130. The heating device 110 can be any device that can provide sufficient heat (at least 374° C.) to the SCWO reactor 120 for the SCWO reactor 120 to execute the SCWO process. Some examples of heating devices can include solar collectors, electric resistance heaters, induction heaters, gas-fired heaters or burners, heat exchangers, and superheated steam injectors.

The SCWO reactor 120 can be a reaction vessel configured to receive a mixture comprising water and organic or inorganic compounds and to maintain conditions above the critical temperature and pressure of water to facilitate oxidation reactions. The SCWO reactor 120 can be designed to operate at temperatures exceeding 374° C. and pressures above 22.1 Megapascals (MPa), such that water exists in a supercritical state, enabling rapid and near-complete oxidation of the compounds into products including CO2, water, and mineral solids. The SCWO reactor 120 can discharge the water from the SCWO process to a water supply tank 140. Any mineral solids can be discharged with the water. Alternatively, the mineral solids can be filtered out and deposited into a separate storage component.

The SCWO reactor 120 can be coupled to the SCCO2 turbine 130 in a way that allows CO2 and heat to transfer from the SCWO reactor 120 to the SCCO2 turbine 130. The SCCO2 turbine 130 can be a turbine configured to receive and expand CO2 maintained at a temperature and pressure above its critical point (approximately 31° C. and 7.38 MPa) to produce mechanical power. The turbine 130 can include one or more stages of rotating and stationary components designed to accommodate the high density and low compressibility of SCCO2 in its supercritical state, enabling efficient energy conversion in compact turbomachinery systems.

The SCCO2 turbine 130 can utilize the heat from the SCWO reactor 120 to heat the CO2 from the SCWO reactor 120 above the critical point of CO2. The SCCO2 turbine 130 can also pressure the CO2 above its critical point to produce mechanical power, which can be used to drive a generator to produce electrical power. In some implementations, the turbine shaft can be mechanically coupled to an electric generator, such that rotation of the turbine results in the generation of electrical energy. In other implementations, the mechanical energy can be used to drive auxiliary equipment, such as pumps, compressors, or mechanical actuators. The mechanical output of the turbine can also be stored or transferred through a mechanical transmission system for use in other components of a power generation or industrial processing system.

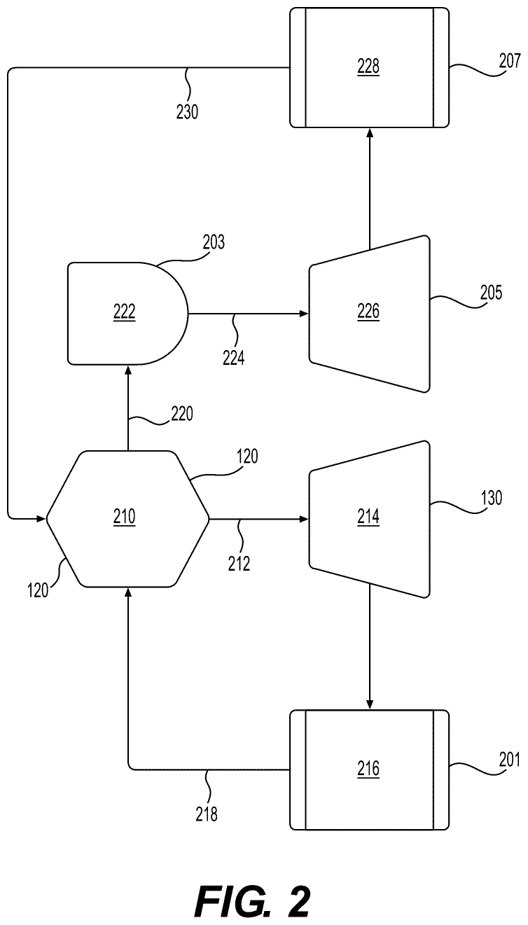

FIG. 2 is a simple flowchart of the operation of a supercritical catalytic converter. At stage 210, the SCWO reactor 120 can facilitate oxidation reactions of a mixture comprising water and organic or inorganic compounds. The SCWO reactor 120 can do this by maintaining conditions above the critical temperature and pressure of water (approximately 374° C. and 22.1 MPa).

Following oxidation within the SCWO reactor 120, the reaction products comprise a mixture of SCH2O, heat, SCCO2, and inorganic solids. Upon exiting the reactor 120, the mixture can be directed to a separation system (not shown), which can include one or more pressure-reducing valves, heat exchangers, and phase separators. As the mixture cools and depressurizes below the critical point of water, phase separation occurs, allowing liquid water to be isolated from gaseous CO₂ and solids.

At stage 220, the SCWO reactor can discharge the supercritical water (SCH2O) produced during the oxidation process through an outlet manifold or conduit for downstream use. The supercritical range may, for example, be specified as any temperature and pressure above the critical point of water (e.g., above approximately 374° C. and 22.1 MPa) or other ranges selected for the particular design. Different implementations may adjust the target range to optimize reaction kinetics, energy efficiency, or equipment safety factors. In some embodiments, the SCH2O can pass through one or more pressure-retaining valves or thermal conditioning components to control flow rate, temperature, or pressure prior to introduction into the steam generator. The SCH2O stream may be directed to a storage tank, heat exchanger, or directly to the steam generator input, depending on system design. This step provides a controlled pathway for the recovered supercritical water to be converted into superheated steam in stage 222.

In alternative embodiments, the SCH2O discharged at stage 220 may be routed to an intermediate storage tank, undergo pre-cooling, or pass through filtration or solids separation before entering the steam generator. In some cases, the supercritical water can be reused directly as a process fluid for other industrial operations rather than solely for steam production.

In some implementations, the effluent stream can be passed through a gas-liquid separator, wherein liquid water is collected and transferred to a steam generator 203 via a fluid conduit at stage 222 (described later herein). The separated CO2, which remains in gaseous form under post-reaction conditions, can be directed through a separate conduit to the SCCO2 turbine 130 at stage 212. Solids can be removed using filtration or settling stages downstream of the initial separation step.

The oxidation reactions within the SCWO reactor 120 can also produce elevated temperatures. This thermal energy can be transferred to the SCCO2 turbine 130 via one or more heat exchange systems at stage 212. In some implementations, the reactor effluent can be directed through a heat exchanger, such as a shell-and-tube or plate-type exchanger, configured to transfer heat from the hot effluent to the SCCO2 without direct contact between streams. In certain embodiments, the SCWO reactor 120 can include an integrated heat recovery system positioned downstream of the reaction zone to maximize thermal transfer before the effluent is cooled and depressurized. Alternatively, thermal energy can be transferred directly if the SCCO2 turbine 130 is thermally coupled to the SCWO reactor 120 through a shared containment structure or thermally conductive interface.

At stage 214, the SCCO2 turbine 130 can bring the CO2 to a supercritical state by applying pressure and the heat received from the SCWO reactor 120, exceeding the critical temperature and pressure of the CO2 (approximately 31° C. and 7.38 MPa). In this supercritical state, the CO2 exhibits properties of both a gas and a liquid, enabling it to act as an efficient working fluid. The heated SCCO2 is then directed into the turbine, where it expands through turbine stages, causing turbine blades to rotate. This expansion converts the thermal energy of the SCCO2 into mechanical energy, which can be used to drive a generator or other mechanical systems.

After expansion through the SCCO2 turbine 130, the SCCO2 can be transferred to a regenerator 201, which is configured to recover residual thermal energy from the expanded working fluid. At stage 216, within the regenerator, the SCCO2 transfers heat to a separate fluid stream or thermal mass, thereby cooling the SCCO2 while capturing usable heat. This cooling step conditions the CO2 for subsequent use in the SCWO reactor 120.

By reducing the temperature of the SCCO2 while maintaining its pressure, the regenerator 201 enables more controlled integration of the CO2 into the SCWO system 120. At stage 218, the cooled SCCO2 exiting the regenerator 201 can be directed to a feed system that introduces the CO2 into the SCWO reactor 120, where it can serve functions such as heat transfer, pressure maintenance, or controlled interaction with the reaction environment. This configuration allows the energy extracted from the SCCO2 turbine 130 to be partially recovered while also preparing the CO2 for downstream processing.

Returning to stage 210 the SCWO reactor 120 can transfer the produced SCH2O to a steam generator 203. The steam generator 203 can be a thermal processing unit configured to receive a working fluid and transfer heat to generate steam for use in mechanical, thermal, or chemical processes. The steam generator 203 can include one or more fluid conduits, heat exchange surfaces, pressure containment structures, and associated control systems to facilitate the conversion of a pressurized, heated fluid into steam under controlled conditions.

In some embodiments, the steam generator 203 can be configured to receive SCH2O, wherein the incoming water is at a temperature and pressure above the critical point of water (374° C. and 22.1 MPa). The SCH2O can be introduced into the steam generator through an inlet manifold or heat exchange interface, and can undergo controlled depressurization and/or thermal exchange to produce high-pressure steam suitable for downstream use, such as in a turbine or process loop.

At stage 222, the steam generator 203 can receive the SCH2O and convert it into superheated steam. Upon entry into the steam generator 203, the SCH2O undergoes controlled depressurization and heat exchange, resulting in a phase transition from the supercritical state to a vapor phase. Additional heat can be applied to raise the temperature of the resulting steam above its saturation point, producing superheated steam suitable for mechanical or thermal applications.

At stage 224, the steam generator can transfer the superheated steam to a steam turbine 205. For example, the steam generator 203 can be operatively coupled to a steam turbine 205, the steam generator 203 can be configured to deliver superheated steam to a turbine inlet of the steam turbine 205.

At stage 226, superheated steam can drive the turbine 205. For example, the superheated steam, having elevated temperature and pressure, can expand through the turbine stages, imparting rotational force to the turbine shaft. This mechanical rotation is harnessed to perform work, such as driving a generator to produce electricity or powering mechanical components within an integrated system.

In some implementations, the mechanical output of the turbine 205 can be used to drive an industrial process. For example, the rotating shaft of the turbine 205 can be mechanically linked to pumps, compressors, or mixers required in chemical manufacturing, refining, or wastewater treatment operations. In other embodiments, the turbine output can be used to power material handling equipment, rotary kilns, or other machinery requiring continuous mechanical input. By directly converting thermal energy from superheated steam into mechanical work, the system enables efficient operation of industrial processes with reduced reliance on separate power sources.

The steam exhaust from the turbine may be recovered for reuse. For example, the steam exhaust can be transferred to a recuperator 207. At stage 228, a recuperator 207 can recover residual thermal energy from the expanded steam. For example, the recuperator 207 can include one or more heat exchange surfaces that facilitate transfer of heat from the turbine exhaust to an incoming process stream, such as the SCH2O feed to the steam generator or another working fluid within the system. As the steam passes through the recuperator 207, it is cooled and, in some cases, partially or fully condensed into liquid water.

At stage 230, the resulting cooled steam or water can be collected and routed to the SCWO reactor 120 for reuse. In certain embodiments, the condensate is pressurized and pre-heated, if necessary, before being introduced into the SCWO reactor 120 as part of the feed mixture. This configuration establishes a closed-loop thermal system in which water exiting the turbine cycle is recycled into the oxidation process, reducing overall water consumption and enhancing thermal efficiency by recovering both heat and mass from the turbine exhaust.

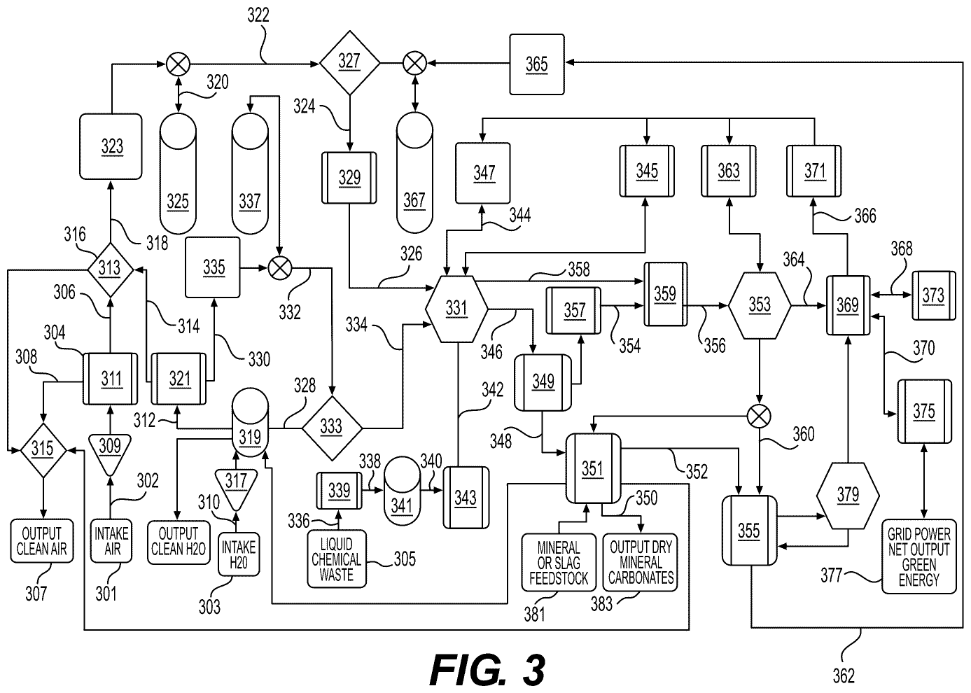

FIG. 3 is a detailed flowchart of a supercritical catalytic converter. Intake air 301, intake water 303, and liquid chemical wastes 305 are used as inputs for a SCWO reactor 331. At stage 302, the intake air 301 can be passed through an intake air filter 309 and into an oxygen concentrator 311.

At stage 304, the oxygen concentrator 311 can separate oxygen from the intake air 301 to produce a concentrated oxygen stream. The oxygen concentrator 311, as used herein, refers to a device configured to separate oxygen from ambient air to produce an oxygen-enriched gas stream. The oxygen concentrator can include one or more air intake systems, filtration units, and gas separation components such as pressure swing adsorption (PSA) beds or membrane modules. In operation, the device receives ambient air and removes nitrogen and other non-oxygen constituents to generate a product stream comprising a higher concentration of oxygen, typically in the range of 90% to 95% by volume. The concentrated oxygen output can be supplied to an oxygen mixer 313 at stage 306, and at stage 308, the oxygen concentrator 311 can output the nitrogen to a clean air mixer 315.

At stage 310, the intake water 303 can be passed through a water filter 317 and into a water supply tank 319. Filtered water in the water supply tank 319 can be used for various purposes in the described process. For example, at stage 312, some of the filtered water can be transferred into a water membrane electrolysis device 321. The water membrane electrolysis device 321 can be a system configured to generate hydrogen and oxygen gases by applying an electrical current to water across a membrane.

At stage 314, the oxygen gases can be transferred into the oxygen mixer 313 with the oxygen supply described at stage 306. At stage 316, the oxygen mixer 313 can combine the two separate oxygen-containing gas streams to produce a single mixed output stream with a desired flow rate or concentration profile. At stage 318, the oxygen mixer 313 can direct the mixed oxygen stream to an oxygen compressor 323, which is configured to compress the gas to a pressure of approximately 2,000 pounds per square inch (psi). At stage 320, the pressurized oxygen can be stored in one or more oxygen storage cylinders 325 until its use is required.

The oxygen mixer 313 can direct any extra or unused oxygen to the clean air mixer 315. The clean air mixer 315 can combine the oxygen from stage 320, the nitrogen from stage 308, and argon from stage 350 (described later herein) and output clean air 307.

At stage 322, the compressed oxygen can be direct to an SCWO gas mixer 327. The SCWO gas mixer 327 can combine the compressed oxygen with compressed CO2 to create a gas mixture that is around 79% CO2 and 21% oxygen. At stage 324, the SCWO gas mixer 327 can direct the gas mixture to an SCWO gas supercharger 329 that pressurized the gas mixture to around 4,000 psi. At stage 326, this pressurized gas mixture can be directed into a SCWO reactor 331 where it is used as an input for supercritical water oxidation.

The SCWO reactor 331 can also use a mixer of water and pressurized hydrogen as input. The water can be provided by the water supply tank 319, which, at stage 328, can direct water into a SCWO mixer 333. The pressurized hydrogen can be provided by the water membrane electrolysis device 321. As described previously, the water membrane electrolysis device 321 can generate hydrogen and oxygen gases by applying an electrical current to water across a membrane. At stage 330, the water membrane electrolysis device 321 can direct the hydrogen to a hydrogen compressor 335. The hydrogen compressor 335 can compress the hydrogen to around 5,000 psi. Any excess or unused hydrogen can be stored in hydrogen storage cylinders 337.

At stage 332, the compressed hydrogen can be directed into the SCWO fuel mixer 333 where the compressed hydrogen is mixed with the water, resulting in a fuel mixture pressurized around 4,000 psi. At stage 334, the SCWO fuel mixer 333 can direct the fuel mixture into the SCWO reactor 331.

The SCWO reactor 331 can also use a liquid waste supply as input. The liquid waste supply can come from liquid chemical waste 305. The liquid chemical waste 305 can be any carbon-based waste in liquid form. At stage 336, the liquid chemical waste 305 can be input into a liquid waste homogenizer 339. The liquid waste homogenizer 339 can be a device configured to process liquid chemical waste by blending, agitating, or emulsifying the contents to produce a uniform mixture. At stage 338, the liquid waste homogenizer 339 can store the uniform mixture in a liquid chemical waste tank 341. At stage 340, when the mixture is required, it can be directed to a liquid waste pump 343 that pressurizes the mixture to 4,000 psi. At stage 342, the liquid waste pump 343 can provide this liquid waste supply as input for the SCWO reactor 331.

The SCWO reactor 331, when activated, can use the inputs (oxygen/CO2 gas mixture, the hydrogen/water mixture, and the liquid waste supply) and maintain conditions above the critical temperature and pressure of water to facilitate oxidation reactions (374° C. and 22.1 MPa). Under these conditions, the water enters a supercritical state, enabling rapid and near-complete oxidation of the compounds into products including CO2, purified water, and mineral solids.

At stage 342, the SCWO control system 345 can control the SCWO reactor 331. The SCWO control system 345 can be configured to monitor and regulate the operational parameters of the SCWO reactor 331 to maintain conditions suitable for supercritical oxidation reactions. The SCWO control system 345 can include one or more sensors, controllers, and actuators in communication with processing equipment to regulate temperature, pressure, flow rate, and oxygen-to-fuel ratios within the reactor.

In operation, the SCWO control system 345 can receive input from temperature sensors, pressure transducers, flow meters, and oxidation-reaction monitors positioned within or near the SCWO reactor 331. In some embodiments, the SCWO control system can also monitor an “oxidation status” of the SCWO reactor. As used herein, oxidation status refers to any measurable indicator of the extent or progress of oxidation reactions occurring within the reactor. Oxidation status can include, for example, one or more of: (i) a measured concentration of residual oxygen or oxidant in the effluent stream, (ii) a measured concentration of carbon-containing species such as CO or unoxidized hydrocarbons, (iii) an oxidation-reduction potential (ORP) value measured within the reaction zone, or (iv) any other metric derived from chemical sensors, spectroscopic probes, or gas analyzers that correlates with the degree of oxidation of the waste feed. The control system can use such oxidation status information, alone or in combination with temperature and pressure readings, to determine whether the reactor is achieving desired conversion levels and to adjust operating parameters (e.g., oxidant flow rate, residence time, or heating input) accordingly.

In some implementations, the oxidation status may also be determined indirectly using algorithmic models or correlations derived from multiple sensor inputs, such as temperature, pressure, and flow data, without a dedicated chemical probe. For example, a control system can infer oxidation completeness based on residence time and thermal profile or apply machine-learning or rule-based logic using historical and real-time operating data to estimate the degree of oxidation.

Based on these inputs, a control unit can execute programmed logic to adjust operational elements such as feed pump speeds, oxygen injection rates, heater output, and pressure relief systems. The SCWO control system 345 can also control auxiliary components, such as preheaters, backpressure regulators, and safety interlocks, to ensure the reactor maintains supercritical conditions (e.g., above 374° C. and 22.1 MPa) and stable oxidation performance. In some embodiments, the SCWO control system 345 can include automated startup and shutdown sequences, fault detection, and emergency shutdown protocols to ensure safe and consistent reactor operation.

At stage 344, an emissions control system 347 can monitor and manage the gaseous outputs produced by a SCWO reactor 331 to reduce or eliminate the release of undesirable byproducts into the environment. The emissions control system 347 can be fluidly coupled to a gas outlet of the SCWO reactor 331 or to a downstream separation unit and can include one or more components such as gas scrubbers, catalytic converters, filters, condensers, or gas analyzers.

During operation, gaseous effluent from the SCWO reactor 331—typically comprising CO2, water vapor, and trace residual gases—can be directed to the emissions control system 347. Sensors positioned within the gas stream detect the presence and concentration of target compounds such as volatile organic compounds (VOCs), nitrogen oxides (NOx), sulfur compounds, or unreacted oxygen. Based on these readings, the emissions control system 347 can activate or adjust treatment components to neutralize or remove specific substances. For example, acid gases can be removed via chemical scrubbing, particulates can be captured by filtration, and residual organics can be oxidized through catalytic treatment. In some configurations, the emissions control system 347 can operate in coordination with the SCWO control system 345 to adjust reactor parameters in response to detected emissions levels, thereby maintaining regulatory compliance and improving overall system performance.

At stage 346, the SCWO reactor 331 can direct output compressed slurry from the SCWO process to a dry gas fractionator 349. The dry gas fractionator 349 can be a separation device configured to receive a high-pressure, high-temperature slurry stream produced by the SCWO reactor 331 and to separate the stream into a hot, dry SCCO2 gas phase and a hot mineral water slurry phase. The fractionator 349 can include a pressure-rated vessel equipped with internal components such as phase separators, demisters, or baffles, and can incorporate temperature and pressure control systems to maintain conditions favorable for gas-liquid separation.

In operation, the compressed effluent slurry from the SCWO reactor—containing SCCO2 gas, water, and suspended or dissolved mineral solids—is introduced into the dry gas fractionator 349 under controlled flow and pressure conditions. Within the vessel, differences in density, phase behavior, and thermodynamic properties of the components allow for stratification or mechanical separation. The SCCO2 gas, being less dense, rises to the upper region of the fractionator 349 and is extracted through a gas outlet, optionally passing through a demister or gas filter to remove entrained moisture or particulates. The denser mineral water slurry settles to the lower portion of the vessel and is discharged through a separate outlet for further processing, cooling, or disposal. This configuration enables the selective recovery of dry, high-purity SCCO2 gas while isolating the aqueous and solid byproducts of the SCWO reaction.

At stage 348, the fractionator 349 can direct the hot mineral water slurry to a mineral carbonate generator 351. The mineral carbonate generator 351, as used herein, can be a reaction and separation system configured to produce dry mineral carbonates 383 through the controlled reaction of hot mineral water slurry, a mineral or slag-based feedstock 381, and hot, dry supercritical CO2 SCCO2 exhaust gas. The generator 351 can include a high-temperature, high-pressure reaction chamber, one or more feed inlets for introducing reactants, and integrated systems for thermal management, product separation, and gas handling. The mineral or slag-based feedstock may include industrial byproducts such as fly ash, steel or nickel slag, cement kiln dust, or naturally occurring silicate minerals like serpentine and olivine. Using such materials facilitates CO2 sequestration and valorization of otherwise waste solids.

In operation, hot mineral water slurry from the fractionator 349 is introduced into the reaction chamber along with a solid feedstock comprising reactive oxides or silicates present in slag, ash, or naturally occurring minerals. Simultaneously, hot dry SCCO2 gas, recovered as exhaust from an upstream SCCO2 turbine 353, is injected into the chamber. Under elevated temperature and pressure conditions, the CO2 reacts with the dissolved and solid-phase metal oxides to form solid mineral carbonates 383. These carbonates 383 precipitate as dry solids and are collected through a solid discharge outlet.

During the carbonation reaction, inert gases present in the system—such as argon introduced through feedstock impurities or process air—remain unreacted and are separated from the product stream. These gases are discharged through a gas outlet and can be collected for reuse or vented. For example, at stage 350, the generator 351 can direct the argon gas to the clean air mixer 315 where the argon can be mixed with nitrogen and oxygen to produce clean air.

The exothermic nature of the mineral carbonation reactions generates excess thermal energy, which can be recovered through heat exchangers integrated into the chamber walls or downstream in the exhaust stream. At stage 352, this recovered heat can be transferred to a thermal recovery and storage unit 355, which is described later herein.

Returning to the fractionator 349, at stage 354 the hot, dry SCCO2 can be directed to an SCCO2 gas supercharger 357 that pressurizes the SCOO2 back to 4,000 psi. At stage 356, the supercharger 357 can direct the compressed SCCO2 into an SCWO thermal recovery and storage manifold 359. The manifold 359 can be configured to capture thermal energy generated by SCWO reactor 331 (stage 358) and transfer that energy to a pressurized SCCO2 working fluid for use in a SCCO2 turbine 353. The manifold can include one or more high-temperature heat exchangers, insulated transfer conduits, and thermal storage media (e.g., molten salt or high-heat-capacity fluids), along with flow and temperature control components.

In operation, the manifold 359 can receive high-temperature effluent—such as supercritical water, steam, or hot gas—exiting the SCWO reactor 331. This thermal energy can transferred to a thermal storage medium or directly to a heat exchanger through which pressurized CO2 from the supercharger 357 flows. The pressurized CO2 is supplied from a separate compression stage and routed through the heat exchanger, where it absorbs heat and is elevated to a temperature above the critical point of cardon dioxide (approximately 31° C.), thereby converting it into a supercritical state.

At stage 356, once the CO2 reaches the desired supercritical temperature and pressure, it can be directed from the thermal recovery manifold 359 into the inlet of SCCO2 turbine 353. The SCCO2 turbine 353 is configured to expand the heated SCCO2, converting its thermal energy into mechanical energy for power generation or mechanical work. This configuration enables recovery of thermal energy from the SCWO reactor and efficient utilization of that energy in a closed-loop SCCO2 power cycle.

The SCCO2 turbine 353 can be controlled by an SCCO2 control system 363. The SCCO2 control system 363 can be configured to monitor and regulate the operational parameters of the SCCO2 turbine 353 to ensure stable and efficient performance. The control system 363 can include one or more sensors, control valves, actuators, flow regulators, and a control unit programmed to maintain target operating conditions for pressure, temperature, mass flow rate, and rotational speed.

In operation, the control system 363 can receive real-time input from sensors positioned at the inlet and outlet of the turbine 353, including temperature sensors, pressure transducers, and flow meters. Based on these inputs, the control unit 363 adjusts various control elements, such as modulating the flow of SCCO2 from the heat source (e.g., a thermal recovery manifold), regulating bypass or recirculation valves, and managing turbine inlet guide vanes or nozzle geometry if applicable. The control system 363 can also communicate with upstream systems to coordinate pressurization and heating of the working fluid.

The SCCO2 turbine 353 can output high voltage electricity and SCCO2 exhaust. The SCCO2 exhaust, now at a low pressure, can be directed to the mineral carbonate generator 351 and the thermal recovery and storage unit 355. The thermal recovery and storage unit 355 can be a system configured to receive hot, dry SCCO2 exhaust from the SCOO2 turbine 353 and waste heat from the mineral carbonate generator 351, and to convert the hot, dry SCCO2 exhaust into cool, dry SCCO2 exhaust for further processing. The thermal recovery and storage unit 355 can include one or more heat exchangers, thermal storage media, and flow control devices operable to extract and store thermal energy from the SCCO2 stream. In some embodiments, at stage 360 any excess recovered heat not required for cooling the SCCO2 exhaust can be transferred to a regenerative steam turbine 379 or a Stirling turbine to produce additional mechanical or electrical power.

Following heat extraction, at stage 362, the resulting low-pressure CO2 can be directed from the thermal recovery and storage unit 355 to a CO2 compressor 365, where it is pressurized to a predetermined operating pressure. The pressurized CO2 can then be transferred into a CO2 storage cylinder 367 for later use or directly supplied to the SCWO gas mixer 327 for combination with other gases in preparation for introduction into the SCWO reactor 331. In certain embodiments, the thermal recovery and storage unit 355 can be integrated with automated control systems to regulate temperature, pressure, and flow rates for both thermal recovery and CO2 handling operations.

At stage 364, the SCCO2 turbine 353 can output the high voltage electricity to a power phase synchronizer 369. The power phase synchronizer 369 can be a device configured to receive high-voltage electrical output from SCCO2 turbine 353 and condition the electrical output for integration with an external power grid or other electrical distribution system. The power phase synchronizer 369 can include one or more voltage regulators, frequency control modules, phase alignment circuits, and switching elements operable to match the phase, frequency, and voltage of the incoming electrical signal to that of the target electrical network.

In operation, the power phase synchronizer 369 can receive high-voltage alternating current generated by the SCCO2 turbine 353 and continuously monitor the waveform characteristics of both the incoming electricity and the grid connection point. The power phase synchronizer 369 then adjusts electrical parameters—such as generator excitation, load balancing, or inverter output—until the phase angle, frequency, and voltage match within allowable tolerances. Once synchronization is achieved, the power phase synchronizer 369 engages a connection switch, enabling seamless transfer of electrical power to the grid or distribution network without inducing electrical transients or instability.

The power phase synchronizer 369 can also receive high voltage electricity from a regenerative steam turbine 379. The regenerative steam turbine 379 can receive recovered heat from the thermal recovery and storage unit 355 and convert the recovered heat into high voltage electricity.

At stage 366, the power phase synchronizer 369 can transfer electrical power to a power distribution bus 371. The power distribution bus 371 can be an electrical conductor or assembly of conductors configured to receive electrical power from one or more power sources and distribute the power to multiple electrical loads. For example, power distribution bus 371 can provide electrical power to the SCCO2 control system 363, SCWO control system 345, and emissions control system 347.

At stage 368, the power phase synchronizer 369 can transfer some of the high voltage electricity to a power storage device 373. The power storage device 373 can be any device capable of storing electrical power, such as a lithium-ion storage device. While lithium-ion batteries are one example, other storage technologies may be used, including supercapacitors, flow batteries, compressed-air energy storage, flywheels, or thermal energy storage systems. The control system can dynamically select or combine storage modes depending on load demand and grid conditions.

At stage 370, the power phase synchronizer 369 can transfer some of the high voltage electricity to an anti-islanding switch 375 and subsequently to a power grid 377. The anti-islanding switch 375 can be a switching device configured to electrically disconnect a power generation source from a power grid or distribution network in response to detection of an islanding condition.

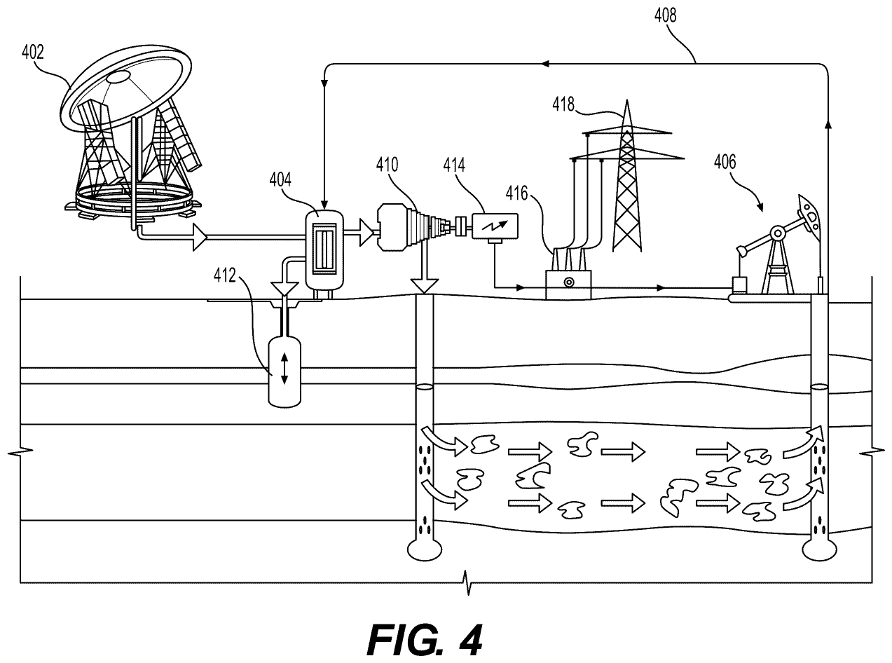

FIG. 4 is an example illustration of a system that implements a super catalytic converter. The system can include one or more heating units 402 that are thermally coupled to an SCWO reactor 404. The heating unit 402 can be any heating device that can elevate the temperature and pressure of the reactor contents to supercritical conditions (374° C.). The heating unit 402 can include electric resistance heaters positioned around or within the reactor vessel to provide direct electrical heating, or induction heaters configured to heat conductive components of the reactor through electromagnetic induction. In certain implementations, the heating unit 402 can be gas-fired heaters or burners used to deliver heat via combustion of fuels such as natural gas or hydrogen, either directly or through an intermediate heat exchanger. In another implementation, the heating unit 402 can be a solar thermal collector (illustrated in FIG. 4), such as parabolic troughs or central receiver systems, which concentrate solar radiation to heat a transfer fluid or thermal storage medium that delivers heat to the SCWO reactor 404. Additional heating configurations can include superheated steam injection systems or molten salt heat exchangers, both of which are operable to transfer thermal energy to the reactor under controlled conditions. One or more of these heating units 402 can be used in combination to maintain or supplement supercritical operating conditions.

The SCWO reactor 404 can be configured to receive carbon-based chemical waste originating from an oil drilling site 406. The waste can include drilling muds, cuttings, oil-based fluids, completion fluids, production chemicals, and other liquid or slurry-phase byproducts generated during drilling, well completion, or production operations. The chemical waste can be delivered to the SCWO reactor 404 through one or more high-pressure feed lines 408, optionally passing through a homogenizer or filtration system (not shown) to ensure consistency in composition and particle size. Once introduced into the SCWO reactor 404, the waste can be combined with water and an oxidizing agent under conditions of elevated temperature and pressure sufficient to maintain a supercritical state. Within the SCWO reactor 404, the carbon-based constituents can be subjected to oxidation reactions that convert them into CO2, water, and mineral solids, thereby reducing the volume and environmental impact of the waste stream.

The SCWO reactor 404 can be configured to provide both thermal energy and SCCO2 to a downstream SCCO2 turbine 410 for power generation. During operation, the SCWO reactor 404 oxidizes carbon-based waste under supercritical conditions, producing high-temperature effluent streams that may include SCH2O, mineral slurry, and gases such as CO2. The SCH2O can be discharged into a storage tank 412 or, alternatively, used in other downstream processes.

The CO2 generated within or recovered from the SCWO process can be pressurized and directed through a heat exchanger thermally coupled to the SCWO reactor 404 or integrated into the reactor structure. The resulting heated and pressurized SCCO2 can be routed to the inlet of the SCCO2 turbine 410, where it expands through one or more turbine stages to produce mechanical energy. This mechanical energy can be transferred to a generator 414 configured to convert rotational motion into high-voltage electricity. The system can operate in a closed loop, with expanded CO2 subsequently cooled, compressed, and recirculated for continued use in the power cycle.

A portion of the high-voltage electricity generated by the SCCO2 turbine 410 can be directed to power drilling equipment 414 at the drill site. This can include equipment such as mud pumps, rotary drives, control systems, lighting, and fluid handling units. The electrical connection can be established through a power distribution bus coupled to a local power generation control system, which regulates voltage and frequency to meet the operational requirements of the drilling systems.

Excess electricity not consumed by on-site operations can be routed through a power phase synchronizer 416 configured to match the phase, voltage, and frequency of the generated power with that of an external electrical grid 418. Once synchronized, the electrical output can be passed through an anti-islanding switch and exported to the grid 418, enabling continuous delivery of surplus power to external consumers or utility infrastructure. This configuration supports both localized energy self-sufficiency and integration with broader power networks.

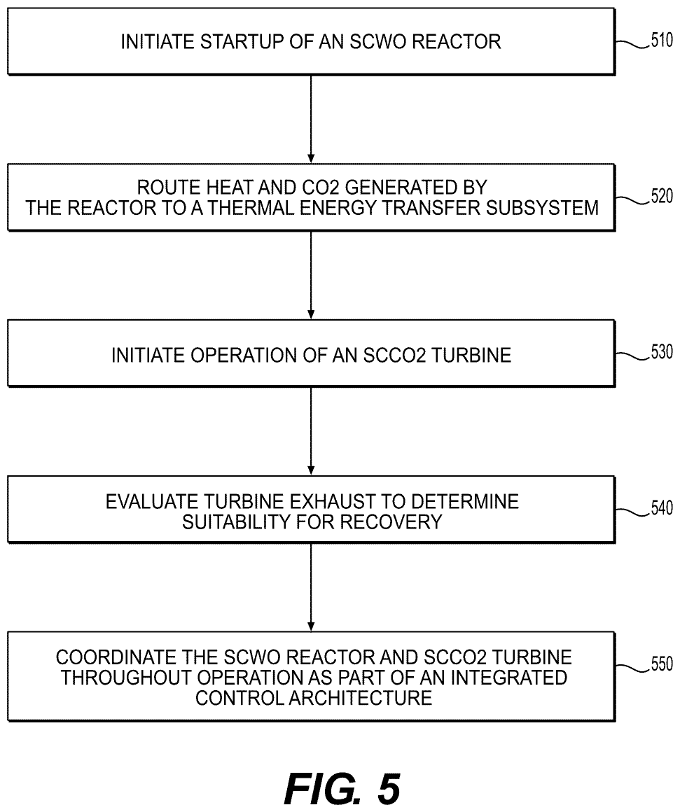

FIG. 5 is an illustration of an example method for operating a super catalytic converter system. At stage 510, a computing device can initiate startup of an SCWO reactor. The computing device can execute a startup sequence stored in memory, which includes activating reactor heating elements or thermal sources, pressurizing the reactor chamber, and preparing feed systems. The computing device controls feed pumps to begin delivering a predetermined volume of water and chemical waste into the reactor inlet under pressure. In parallel, it activates an oxidant delivery system (e.g., an oxygen concentrator or gas mixer) to introduce an oxidizing agent into the reactor.

The computing device can monitor pressure and temperature sensors distributed within and around the reactor to determine when the internal environment reaches supercritical conditions—typically exceeding 374° C. and 22.1 MPa. At stage 520, upon achieving supercritical conditions, the computing device can permit continuous feed of the reactant mixture and oxidant, maintaining steady-state operation of the reactor. Throughout operation, the computing device can regulate parameters such as flow rates, oxidant-to-fuel ratios, and heating input to sustain stable oxidation and maximize conversion of carbon-based compounds.

At stage 520, once the SCWO reactor reaches operating conditions, the computing device can control the routing of heat and CO2 generated by the reactor to a thermal energy transfer subsystem. The computing device can activate valves and heat exchangers configured to extract thermal energy from the reactor's effluent, which includes SCH2O, CO2, and mineral-laden slurry. The computing device can determine whether the heat available is sufficient to raise the temperature of a separate pressurized CO2 stream to supercritical levels.

In implementations using an indirect heat exchange configuration, the computing device can monitor inlet and outlet temperatures and flow rates of the CO2 stream passing through the heat exchanger. Based on this data, the computing device can modulate flow control valves, heating power levels, or bypass routes to achieve a target temperature and pressure for the SCCO2 stream. The computing device can also regulate auxiliary heating systems, such as electric or combustion heaters, to supplement the thermal input as needed. Once the SCCO2 stream reaches required turbine inlet conditions, the system transitions to turbine operation.

At stage 530, the computing device can initiate operation of the SCCO2 turbine by opening a control valve or actuator that allows the supercritical CO2 to flow into the turbine inlet. As the SCCO2 expands through the turbine stages, it converts thermal energy into mechanical energy, rotating the turbine shaft. The computing device can monitor rotational speed, torque, temperature, and pressure at various points along the turbine and generator assembly. If measured parameters deviate from predefined limits, the computing device dynamically adjusts SCCO2 flow rates, bypass valve positions, or pressure regulators.

The computing device can also monitor electrical output from a generator mechanically coupled to the turbine. This can include tracking voltage, current, and frequency to ensure the generated electricity meets the requirements of downstream systems. If needed, the computing device can coordinate with a power generation control system to manage generator excitation or load-sharing across multiple generation units. In some embodiments, the computing device can regulate the turbine inlet conditions to maximize electrical efficiency under changing load demands or environmental conditions.

In some embodiments, the control system maintains a target electrical output profile, which may include a constant or scheduled power level, ramping patterns, or grid-following/islanding modes, and may be dynamically adjusted in response to load demand or grid operator signals.

At stage 540, as the SCCO2 exhaust exits the turbine, the computing device can evaluate its residual thermal energy to determine suitability for recovery. If exhaust temperature and pressure exceed threshold values, the computing device can direct the SCCO2 stream to a thermal recovery unit. Within this unit, the computing device regulates flow across heat exchangers or into a thermal storage medium, such as a molten salt tank or phase-change material chamber. This enables partial recovery of thermal energy for reuse elsewhere in the system, such as for reheating CO2 or water streams.

Once thermal energy has been extracted, the computing device can initiate transfer of the now cooled and depressurized CO2 to a CO2 handling subsystem. This can involve routing the gas to a compressor, which the computing device activates and regulates to pressurize the CO2 for storage or reuse. Pressure sensors and flow meters are monitored in real time to ensure the CO2 is compressed to the required setpoint. The computing device then either stores the pressurized CO2 in a storage tank or directs it to a SCWO gas mixer for reintroduction into the reactor system.

At stage 550, the computing device can coordinate the SCWO reactor and SCCO2 turbine throughout operation as part of an integrated control architecture. The computing device can continuously receive data from distributed sensors, including temperature, pressure, flow rate, oxidation efficiency, and electrical output. Based on this input, the computing device can execute control logic to maintain thermal balance, optimize power generation, and regulate fluid circulation across subsystems.

The computing device can also execute diagnostic routines and fault detection algorithms. In the event of an anomaly—such as overpressure, temperature excursions, or turbine overspeed—the computing device can initiate corrective action, which can include throttling flow, activating emergency shutoff valves, or initiating a system shutdown. In some implementations, the computing device also manages automated startup and shutdown sequences, load-following algorithms, and thermal optimization routines. This allows the system to operate continuously and autonomously, responding to varying waste feed conditions, thermal loads, or electrical demand profiles.

The described control functionality may be implemented using programmable logic controllers (PLCs), dedicated hardware circuits, or software modules executed by local or remote computing systems. Sensor data may be transmitted over wired or wireless networks and processed using predictive control algorithms, AI-based optimizers, or cloud-based supervisory platforms to improve efficiency and maintenance planning.

Other examples of the disclosure will be apparent to those skilled in the art from consideration of the specification and practice of the examples disclosed herein. Though some of the described methods have been presented as a series of steps, it should be appreciated that one or more steps can occur simultaneously, in an overlapping fashion, or in a different order. The order of steps presented are only illustrative of the possibilities and those steps can be executed or performed in any suitable fashion. Moreover, the various features of the examples described here are not mutually exclusive. Rather any feature of any example described here can be incorporated into any other suitable example. It is intended that the specification and examples be considered as exemplary only, with a true scope and spirit of the disclosure being indicated by the following claims.

What is claimed is:

1. A system for thermal processing and energy generation, comprising:
a supercritical water oxidation (SCWO) reactor configured to receive a mixture comprising water and a carbon-based waste stream and to oxidize the carbon-based waste at a temperature and pressure above a critical point of water, thereby producing an effluent stream comprising supercritical water, carbon dioxide, and heat;
a heating unit thermally coupled to the SCWO reactor and configured to supply thermal energy sufficient to maintain the temperature and pressure of the SCWO reactor above the critical point of water;
a supercritical carbon dioxide (SCCO2) turbine fluidly coupled to the SCWO reactor and configured to receive supercritical carbon dioxide generated by the SCWO reactor, expand the supercritical carbon dioxide to produce mechanical energy, and discharge a turbine exhaust stream; and
a generator mechanically coupled to the SCCO2 turbine and configured to convert the mechanical energy into electrical energy.

2. The system of claim 1, further comprising a thermal transfer unit fluidly and thermally coupled to the SCWO reactor and the SCCO2 turbine, the thermal transfer unit configured to receive heat and carbon dioxide from the SCWO reactor and transfer the heat to a pressurized carbon dioxide stream to generate the supercritical carbon dioxide supplied to the SCCO2 turbine.

3. The system of claim 1, further comprising a control system operatively coupled to the SCWO reactor, the heating unit, and the SCCO2 turbine, the control system comprising a computing device programmed to regulate the operation of the heating unit to maintain supercritical conditions within the SCWO reactor and to control a flow of SCCO2 into the SCCO2 turbine based on one or more measured operating parameters.

4. The system of claim 1, further comprising:
a thermal recovery unit configured to receive a turbine exhaust stream from the SCCO2 turbine, extract residual heat from the turbine exhaust stream, and produce a cooled carbon dioxide stream; and
a carbon dioxide compressor fluidly coupled to the thermal recovery unit and configured to pressurize the cooled carbon dioxide stream for storage or recirculation.

5. The system of claim 1, further comprising a gas mixer configured to receive carbon dioxide from the SCCO2 turbine or a carbon dioxide compressor and to combine the carbon dioxide with one or more additional gases to produce a mixed gas stream for introduction into the SCWO reactor.

6. The system of claim 1, wherein the heating unit comprises a solar thermal collector configured to concentrate solar energy and transfer thermal energy to the SCWO reactor to maintain the temperature and pressure above the critical point of water.

7. The system of claim 1, further comprising an emissions control system fluidly coupled to the SCWO reactor and configured to receive gaseous byproducts from the reactor and remove or neutralize one or more target compounds prior to atmospheric release.

8. The system of claim 1, wherein the generator is electrically coupled to a power phase synchronizer configured to match the phase, voltage, and frequency of a generated electrical output of the generator to an external electrical grid.

9. The system of claim 1, further comprising a power distribution bus electrically connected to the generator and configured to distribute electrical power to one or more downstream loads.

10. The system of claim 1, wherein the SCCO2 turbine is configured to discharge an exhaust stream, and further comprising a regenerative steam turbine thermally coupled to the exhaust stream and configured to convert residual thermal energy into additional mechanical or electrical power.

11. A method of operating a thermal processing and energy generation system, comprising:
initiating operation of a supercritical water oxidation (SCWO) reactor by controlling a heating unit to elevate a temperature and pressure within the reactor above a critical point of water;
delivering a mixture comprising water and carbon-based waste into the SCWO reactor and controlling an injection of an oxidizing agent to facilitate oxidation of the carbon-based waste under supercritical conditions, thereby generating heat and producing an effluent stream comprising carbon dioxide;
heating a pressurized carbon dioxide stream using heat generated by the SCWO reactor to produce supercritical carbon dioxide (SCCO2);
directing the SCCO2 to an SCOO2 turbine and controlling a flow of SCCO2 into the turbine to cause expansion of the SCCO2 and generation of mechanical energy; and
operating a generator mechanically coupled to the turbine to convert the mechanical energy into electrical energy.

12. The method of claim 11, further comprising controlling a thermal recovery unit to receive an exhaust stream from the SCCO2 turbine, extract residual heat from the exhaust stream, and produce a cooled carbon dioxide stream.

13. The method of claim 11, further comprising operating a carbon dioxide compressor to receive and pressurize a cooled carbon dioxide stream for recirculation or storage.

14. The method of claim 11, further comprising controlling a gas mixer to receive the carbon dioxide from the turbine and to combine the carbon dioxide with an oxidizing agent to form a mixed gas stream for reintroduction into the SCWO reactor.

15. The method of claim 11, further comprising regulating an electrical output from the generator by controlling a power phase synchronizer to match a voltage, frequency, and phase of the output to an external electrical grid.

16. A non-transitory, computer-readable medium containing instructions that, when executed by a hardware-based processor, causes the processor to perform stages for operating a thermal processing and energy generation system, the stages comprising:
initiating operation of a supercritical water oxidation (SCWO) reactor by activating a heating unit to elevate a reactor temperature and pressure above a critical point of water;
causing one or more pumps or valves to deliver a mixture comprising water and carbon-based waste into the SCWO reactor;
causing an oxidant injection system to deliver an oxidizing agent into the SCWO reactor;
receiving sensor data from the SCWO reactor indicating at least one of temperature, pressure, or oxidation status;
determining whether the SCWO reactor is operating within a predefined supercritical range based on the sensor data;
activating a flow control device to direct supercritical carbon dioxide (SCCO2) into an SCCO2 turbine when the SCCO2 meets predefined temperature and pressure conditions;
monitoring operating parameters of the SCCO2 turbine, including rotational speed and inlet pressure; and
controlling an output of a generator mechanically coupled to the turbine to maintain a target electrical output profile.

17. The non-transitory, computer-readable medium of claim 16, the stages further comprising causing a carbon dioxide compressor to compress a cooled carbon dioxide stream for storage or reuse.

18. The non-transitory, computer-readable medium of claim 16, the stages further comprising causing gas mixer to combine a compressed carbon dioxide with an oxidizing agent for reintroduction into the SCWO reactor.

19. The non-transitory, computer-readable medium of claim 16, the stages further comprising causing a power phase synchronizer to match the phase, frequency, and voltage of the generator output to an external electrical grid.

20. The non-transitory, computer-readable medium of claim 16, the stages further comprising monitoring temperature and pressure conditions within the SCWO reactor and adjusting the operation of the heating unit to maintain the reactor above the critical point of water.
